(19) United States
(12) Patent Application Publication
(10) Pub. No.: US 2010/0237286 A1
(43) Pub. Date: Sep. 23, 2010

(54) LIQUID CRYSTAL MIXTURE

(75) Inventors: Yu-Ying HSIEH, Kaohsiung County (TW); Shu-Ling LO, Kaohsiung County (TW)

Correspondence Address: YOUNG & THOMPSON, 209 Madison Street, Suite 500, Alexandria, VA, 22314, US

(73) Assignee: DAILY POLYMER CORP., Kaohsiung Hsien (TW)

(21) Appl. No.: 12/406,594

(22) Filed: Mar. 18, 2009

(51) Int. Cl. C09K 19/30

(52) U.S. Cl. 252/299.63

(57) ABSTRACT

A liquid crystal mixture includes 10 to 25 parts by weight of a first composition including at least one compound having the following formula (A)

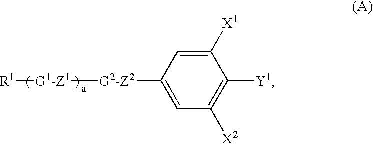

5 to 55 parts by weight of a second composition including at least one perfluoroallyloxy compound having the following formula (B)

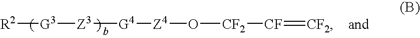

35 to 80 parts by weight of a third composition including at least one compound having the following formula (C)

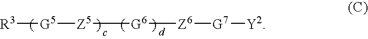

### BACKGROUND OF THE INVENTION

1. Field of the Invention

This invention relates to a liquid crystal mixture, more particularly to a liquid crystal mixture used in manufacturing a liquid crystal display having a large size.

2. Description of the Related Art

Because of its characteristics including thin size, lightweight, low power consumption, and no radiation, a liquid crystal display has been widely employed in several products, e.g., a mobile phone, a digital camera, a radiophone, a monitor, a television set, a laptop computer, etc. With technical developments for various new products, the size of the liquid crystal display can range from 2 inches to 42 inches. A liquid crystal television with a large size is strongly demanded on the market. However, for a large liquid crystal television, the most serious problem is that it requires a long time for response. In particular, due to the large dimension of the display, the alignment of the liquid crystal molecules cannot be swiftly changed in response to variation in the electric field. As a result, a poor polarization and orientation change of light would become undesirably slow, thereby resulting in a poor brightness contrast effect. Thus, it is needed to shorten the time of response in manufacturing the large liquid crystal display so as to minimize the effect of image sticking. Conventionally, shortening of response time can be accomplished by the following two methods. First method is proffered based upon the facts that the response time is inversely proportional to the square of a thickness (d) of a liquid crystal cell, and that refractive index anisotropy (Δn) multiplied by d is a constant value. Thus, by raising Δn value and reducing d value, the response time can be reduced. In the second method, efforts are directed to reduce the rotational viscosity (γ₁) of a liquid crystal composition/mixture. For a liquid crystal display with a large size, it is required industry wide that the response time be less than 5.5 msec and Δn be greater than 0.11. Therefore, how to shorten a response time (RT), to increase Δn, and to reduce γ₁ have always been challenging tasks in this field.

U.S. Pat. No. 7,001,647 discloses a perfluoroallyloxy compound represented by the following formula.

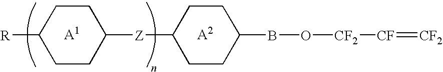

In the formula, R represents R′, R′O, R′OCO, or R′COO; R′ represents an alkyl group which may have an unsaturated bond, a —CH₂— moiety of the alkyl group may be displaced with —O—, —CO—, or —COO—, and a part or all of the hydrogen atoms of the alkyl group may be substituted with a halogen atom or a cyano group; A¹ and A² each represent 1,4-phenylene (a —CH═ moiety of which may be displaced with —N═, and a part or all of the hydrogen atoms of which may be substituted with a halogen atom or a cyano group) 1,4-cyclohexylene (a —CH₂— moiety of which may be displaced with —O— or —S—, and a part or all of the hydrogen atoms of which may be substituted with a halogen atom or a cyano group), 2,6-naphthylene, or 2,6-decahydronaphthylene; Z represents a single bond, —COO—, OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂CH═CH—, —C≡C—, —CF₂O—, or —OCF₂—; B represents a single bond or an alkylene group, a part or all of the hydrogen atoms of the alkylene group may be substituted with a halogen atom or a cyano group; and n represents 1, 2, or 3; when n is 2 or 3, A¹ and Z may each be the same or different. The perfluoroallyloxy compound can be mixed with nematic liquid crystal materials to provide several liquid crystal compositions.

In a PCT patent application, i.e., WO 2006/061966, there is disclosed a liquid crystal composition containing 15% by mass or more of a compound having a terminal structure represented by the following formula.

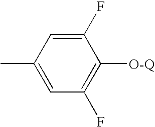

In the aforesaid formula, Q represents a saturated or unsaturated alkyl group having 1-8 carbon atoms which may be substituted by a halogen atom.

Although several liquid crystal compositions are disclosed in the aforesaid patent or patent applications, Δn for all of the disclosed liquid crystal compositions is less than 0.11, which does not meet the industry requirements for a liquid crystal display with a large size (Δn>0.11). In addition, response time is not particularly addressed in the aforesaid patent or patent applications, not to mention the solution to the problem of long response time.

Therefore, there is a need in the art to provide a liquid crystal mixture that can provide, e.g., short response time (<5.5 msec), relatively high Δn (>0.11), relatively low γ₁, or a superior stability at a low temperature.

### SUMMARY OF THE INVENTION

According to this invention, a liquid crystal mixture includes 10 to 25 parts by weight of a first composition, 5 to 55 parts by weight of a second composition, and 35 to 80 parts by weight of a third composition. The first composition includes at least one compound having the following formula (A):

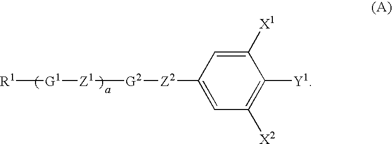

The second composition includes at least one perfluoroallyloxy compound having the following formula (B):

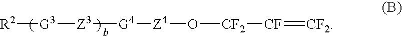

The third composition includes at least one compound having the following formula (C):

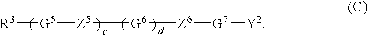

G¹, G², G³, G⁴, G⁵, and G⁶ independently represent 1,4-phenylene, 1,4-cyclohexylene, 2,6-naphthylene, or 2,6-decahydronaphthylene, a —CH═ moiety of the 1,4-phenylene being optionally substituted with —N═, each of hydrogen atoms of the 1,4-phenylene being optionally substituted with a halogen atom or a cyano group, a CH₂-moiety of the 1,4-cyclohexylene being optionally substituted with —O— or —S—, each of hydrogen atoms of the 1,4-cyclohexylene being optionally substituted with a halogen atom or a cyano group. G⁷ represents 1,4-phenylene, 3-fluoro-1,4-phenylene, 5-fluoro-1,4-phenylene, 1,4-cyclohexylene, 2,6-naphthylene, or 2,6-decahydronaphthylene. Z¹, Z², Z³, Z⁵, and Z⁶ independently represent a single bond, —COO—, —OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂H═CH—, —C≡C—, —CF₂O—, or —OCF₂—. Z⁴ represents a single bond or an alkylene group, each of hydrogen atoms of the alkylene group being optionally substituted with a halogen atom or a cyano group. R¹, R², and R³ independently represent R or RO, R being an alkyl group which optionally has at least one double bond, a —CH₂— moiety of the alkyl group being optionally substituted with —O—, —CO—, or —COO—, and each of hydrogen atoms of the alkyl group being optionally substituted with a halogen atom or a cyano group. X¹, X², and Y¹ independently represent —H, —F, —CF₃—, —OCF₃—, —OCF₂H—, or —OCFH₂—, with the proviso that, when X¹ and X² are hydrogen, Y¹ cannot be H, F, or —OCFH₂—. Y² represents F, Cl, —OCFH₂, a linear or branched C₁-C₇ alkyl group, a linear or branched C₁-C₇ alkoxy group, or a C₂-C₇ alkenyl group, with the proviso that, when G⁷ is 3-fluoro-1,4-phenylene or 5-fluoro-1,4-phenylene, Y cannot be F, Cl, or —OCFH₂. a is 0, 1 or 2, in which, when a is 2, G¹ and Z¹ in each occurrence are independently the same or different. b is 1, 2, or 3, in which, when b is 2 or 3, G³ and Z³ in each occurrence are independently the same or different. c and d are independently 0, 1, or 2, and c+d>0, in which, when c is 2, G⁵ and Z⁵ in each occurrence are independently the same or different.

### DETAILED DESCRIPTION OF THE PREFERRED EMBODIMENTS

A liquid crystal mixture according to this invention is obtained by mixing 10 to 25 parts by weight of a first composition, 5 to 55 parts by weight of a second composition, and 35 to 80 parts by weight of a third composition.

The first composition includes at least one compound having the following formula (A):

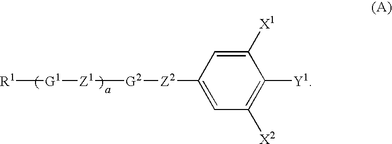

The second composition includes at least one perfluoroallyloxy compound having the following formula (B):

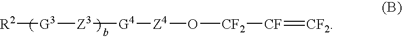

The third composition includes at least one compound having the following formula (C):

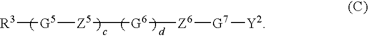

In compounds (A), (B), and (C), G¹, G², G³, G⁴, G⁵, and G⁶ independently represent 1,4-phenylene, 1,4-cyclohexylene, 2,6-naphthylene, or 2,6-decahydronaphthylene. When G¹, G², G³, G⁴, G⁵, and G⁶ are independently 1,4-phenylene, a —CH═ moiety of the 1,4-phenylene is optionally substituted with —N═, and each of hydrogen atoms of the 1,4-phenylene is optionally substituted with a halogen atom or a cyano group. When G¹, G², G³, G⁴, G⁵, and G⁶ are independently 1,4-cyclohexylene, a —CH₂— moiety of the 1,4-cyclohexylene is optionally substituted with —O— or —S—, and each of hydrogen atoms of the 1,4-cyclohexylene is optionally substituted with a halogen atom or a cyano group.

G⁷ represents 1,4-phenylene, 3-fluoro-1,4-phenylene, 5-fluoro-1,4-phenylene, 1,4-cyclohexylene, 2,6-naphthylene, or 2,6-decahydronaphthylene.

Z¹, Z², Z³, Z⁵, and Z⁶ independently represent a single bond, —COO—, —OCO—, —CH₂CH₂—, —CH═CH—, —(CH₂)₄—, —CH₂O—, —OCH₂—, —CH₂)₃O—, —O(CH₂)₃—, —CH═CHCH₂—O—OCH₂CH═CH—, —C≡C—, —CF₂O—, or —OCF₂—.

Z⁴ represents a single bond or an alkylene group, and each of hydrogen atoms of the alkylene group is optionally substituted with a halogen atom or a cyano group.

R¹, R², and R³ independently represent R or RO. R is an alkyl group which optionally has at least one double bond, a —CH₂— moiety of the alkyl group is optionally substituted with —O—, —CO—, or —COO—, and each of hydrogen atoms of the alkyl group is optionally substituted with a halogen atom or a cyano group.

X¹, X², and Y¹ independently represent H, F, —CF₃—, —OCF₃—, —OCF₂H—, or —OCFH₂—, with the proviso that, when X¹ and X² are hydrogen, Y¹ cannot be H, F, or —OCFH₂—.

Y² represents F, Cl, —OCFH₂, a linear or branched C₁-C₇ alkyl group, a linear or branched C₁-C₇ alkoxy group, or a C₂-C₇ alkenyl group, with the proviso that, when G⁷ is 3-fluoro-1,4-phenylene or 5-fluoro-1,4-phenylene, Y cannot be F, Cl, or —OCFH₂.

a is 0, 1 or 2, in which, when a is 2, G¹ and Z¹ in each occurrence are independently the same or different.

b is 1, 2, or 3, in which, when b is 2 or 3, G³ and Z³ in each occurrence are independently the same or different.

c and d are independently 0, 1, or 2, and c+d>0, in which, when c is 2, G⁵ and Z⁵ in each occurrence are independently the same or different.

In the liquid crystal mixture of this invention, the first composition including a compound having at least two fluorine atoms exhibits a relatively high polarity, thus providing a high dielectric anisotropy (Δ∈) property and high impedance. The second composition including a perfluoroallyloxy compound provides the following properties, i.e., low γ₁, relatively high Δ∈, high clearing point (Tₙᵢ), high impedance, and superior stability at a low temperature. The third composition exhibits a relatively low polarity, thus providing low γ₁ and high Tₙᵢ. When the first composition is present in an amount greater than 25 parts by weight, the lowest storage temperature (T_{L}) will be raised. When the second composition is present in an amount greater than 55 parts by weight, the response time will be increased. When the second composition is not included in the liquid crystal mixture of this invention, the response time will be increased and the lowest storage temperature (T_{L}) will be raised. When the third composition is present in an amount less than 35 parts by weight, the response time will be increased. When the third composition is present in an amount greater than 80 parts by weight, the lowest storage temperature (T_{L}) will be raised. Therefore, the first, second, and third compositions in the liquid crystal mixture should be maintained at specific parts by weight, i.e., 10 to 25 parts by weight, 5 to 53 parts by weight, and 35 to 80 parts by weight, respectively, so as to obtain the desired physical properties necessary for a liquid crystal display with a large size, i.e., superior stability at relatively low temperature, relatively high Δn, and short response time (RT). Moreover, with the specific weight ratio, other properties of the liquid crystal mixture according to this invention, i.e., Tₙᵢ, Δ∈, Vₜₕ, and γ₁ also meet the industry requirements.

Preferably, the first composition is present in an amount ranging from 10 to 25 parts by weight, the second composition is present in an amount ranging from 5 to 45 parts by weight, and the third composition is present in an amount ranging from 45 to 80 parts by weight. More preferably, the first composition is present in an amount ranging from 10 to 25 parts by weight, the second composition is present in an amount ranging from 6 to 42 parts by weight, and the third composition is present in an amount ranging from 44 to 80 parts by weight.

Preferably, in the compound (A), G¹ and G² independently represent 1,4-phenylene, 1,4-cyclohexylene, 3-fluoro-1,4-phenylene, 5-fluoro-1,4-phenylene, or 3,5-difluoro-1,4-phenylene. X¹ and X² independently represent H or F, and Y¹ represents F, —CF₃, or —OCF₃, with the proviso that, when X¹ and X² are H, Y¹ is —CF₃ or —OCF₃.

Preferably, examples of the compound (A) include:

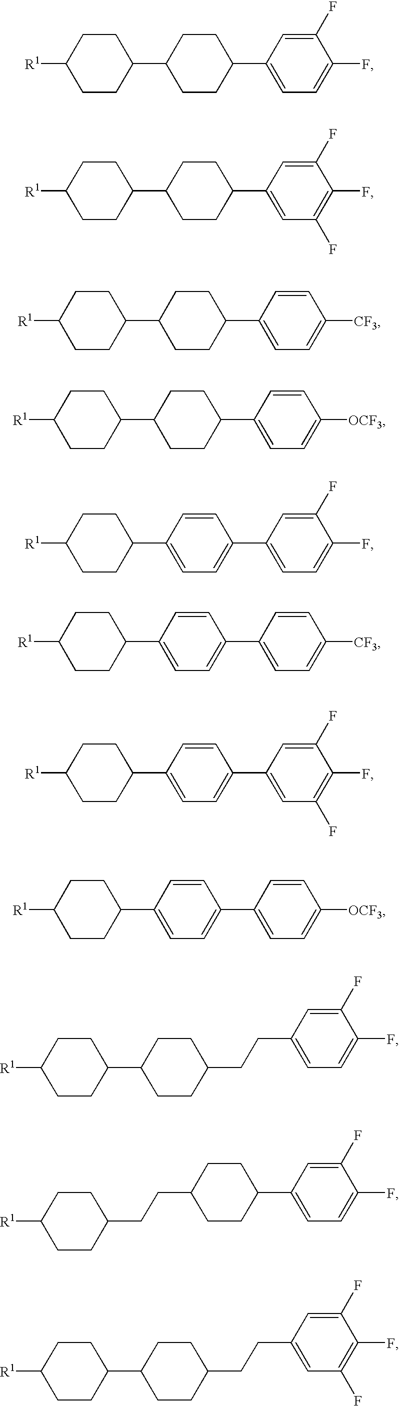

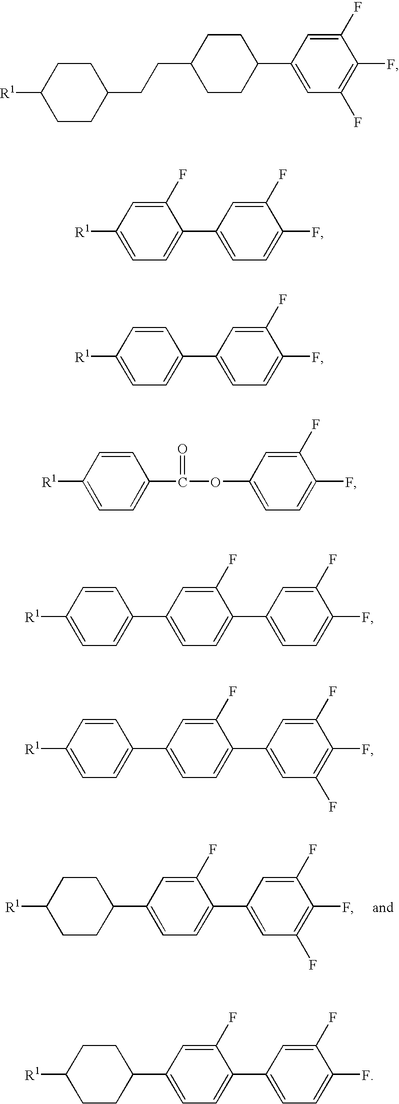

More preferably, in the compound (A), R¹ represents R or RO, and R is a linear or branched C₁-C₇ alkyl group, or a linear or branched C₂-C₇ alkyl group having an unsaturated bond. Examples of the compound (A) include:

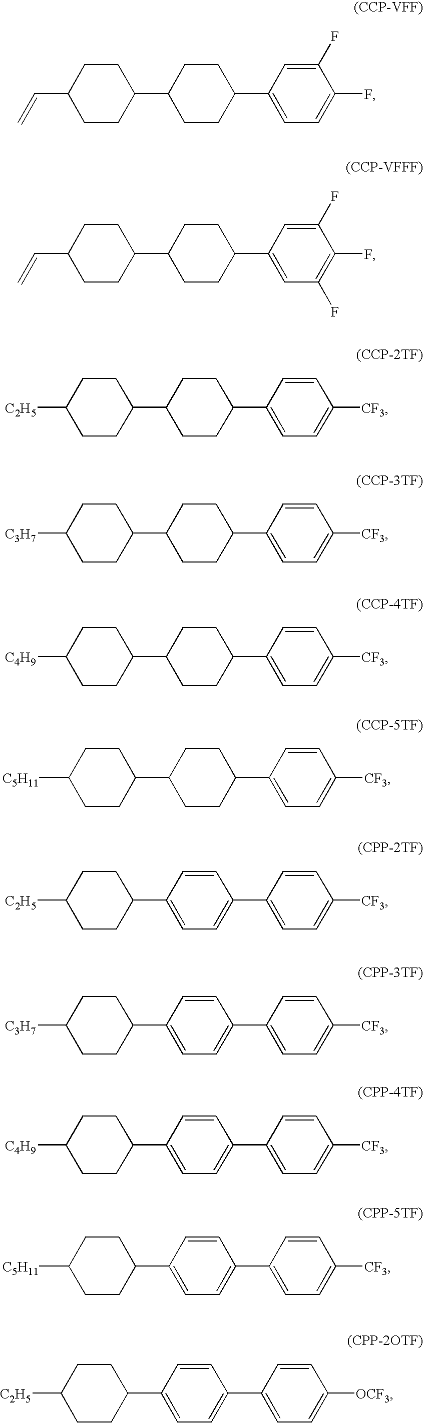

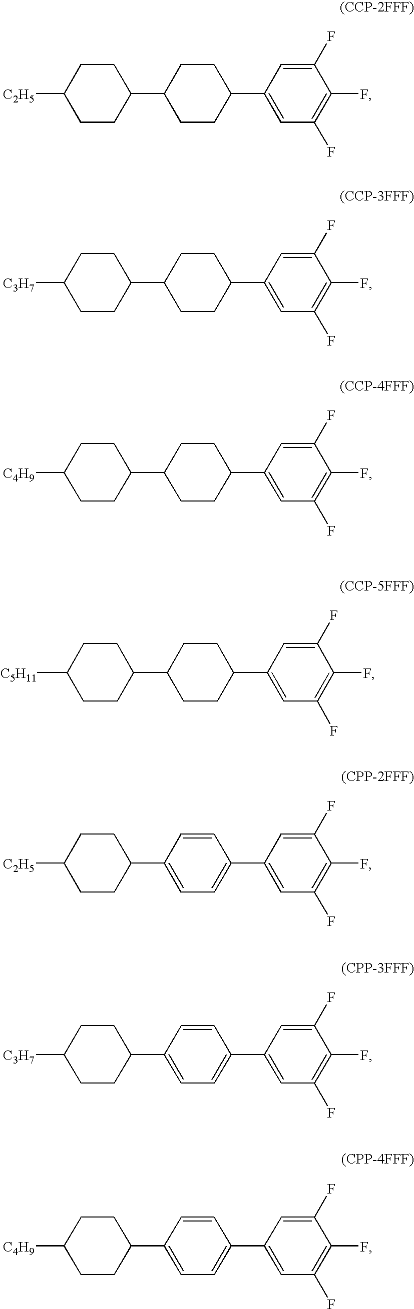

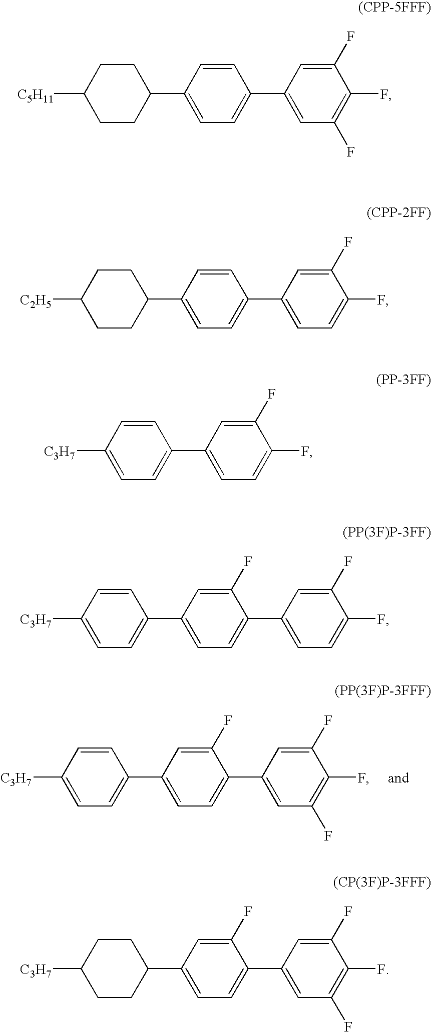

The specific examples of the compound (A) used in the embodiments of this invention include CCP-VFF, CCP-2TF, CCP-3TF, CPP-3TF, CPP-5TF, CPP-20TF, CCP-3FFF, CCP-4FFF, CPP-3FFF, CPP-5FFF, CPP-2PF, PP-3FF, PP(3F)P-3FF, and PP(3F)P-3FFF.

It should be noted that each compound is abbreviated, e.g., CCP-3FF indicates two cyclohexylene groups, one phenylene group, 3 carbons for R¹, and two fluorine atoms.

Preferably, in the perfluoroallyloxy compound (B), G³ and G⁴ independently represent 1,4-phenylene, 1,4-cyclohexylene, 3-fluoro-1,4-phenylene, 5-fluoro-1,4-phenylene, or 3,5-difluoro-1,4-phenylene.

Examples of the perfluoroallyloxy compound (B) include:

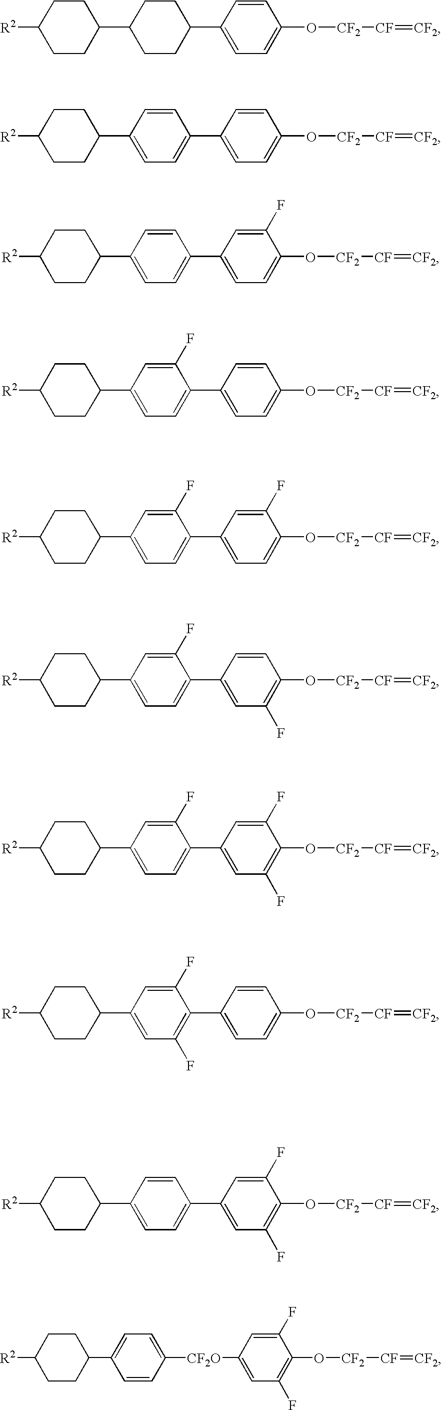

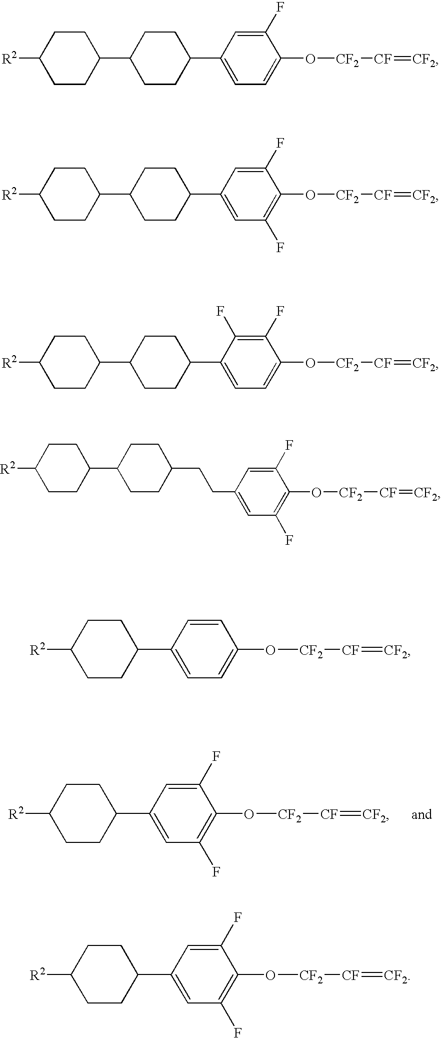

More preferably, examples of the perfluoroallyloxy compound (B) include:

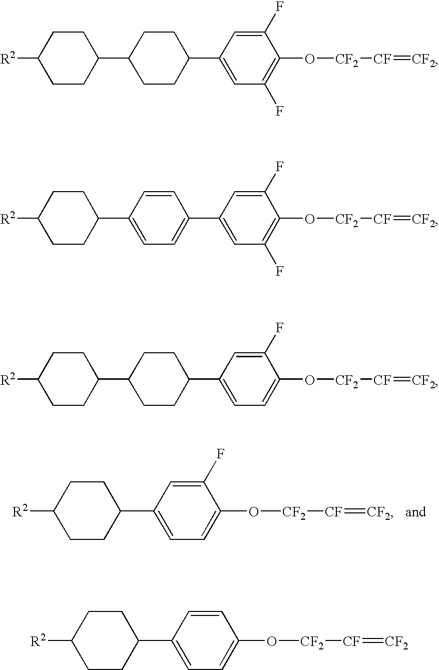

Preferably, in the perfluoroallyloxy compound (B) R² represents R or RO. R is a linear or branched C₁-C₇ alkyl group, or a linear or branched C₂-C₇ alkyl group having an unsaturated bond. Examples of the compound (B) include:

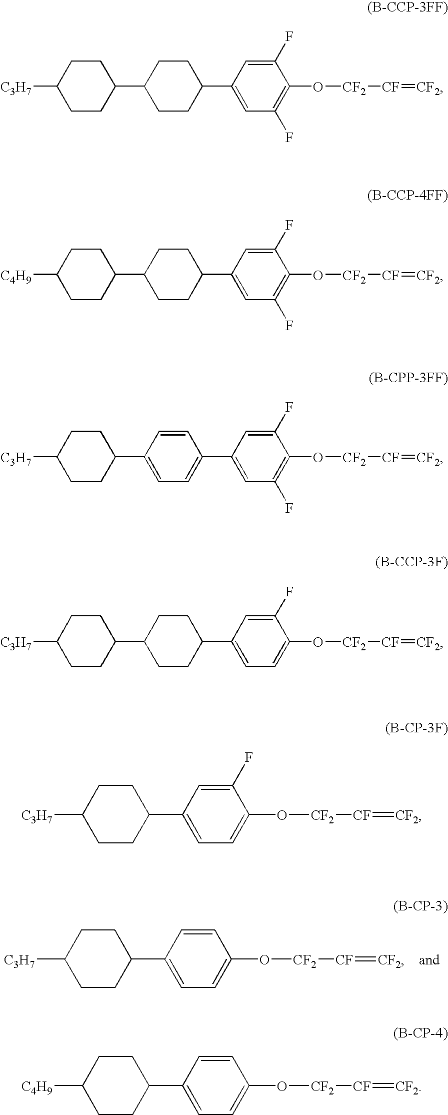

The specific examples of the compound (B) used in the embodiments of this invention include B-CCP-3FF, B-CCP-4FF, B-CPP-3FF, BCP-3F, B-CP-3, and B-CP-4.

Preferably, in the compound (C), G⁵, G⁶, and G⁷ independently represent 1,4-phenylene, 3-fluoro-1,4-phenylene, 5-fluoro-1,4-phenylene, or 1,4-cyclohexylene.

Preferably, examples of the compound (C) include:

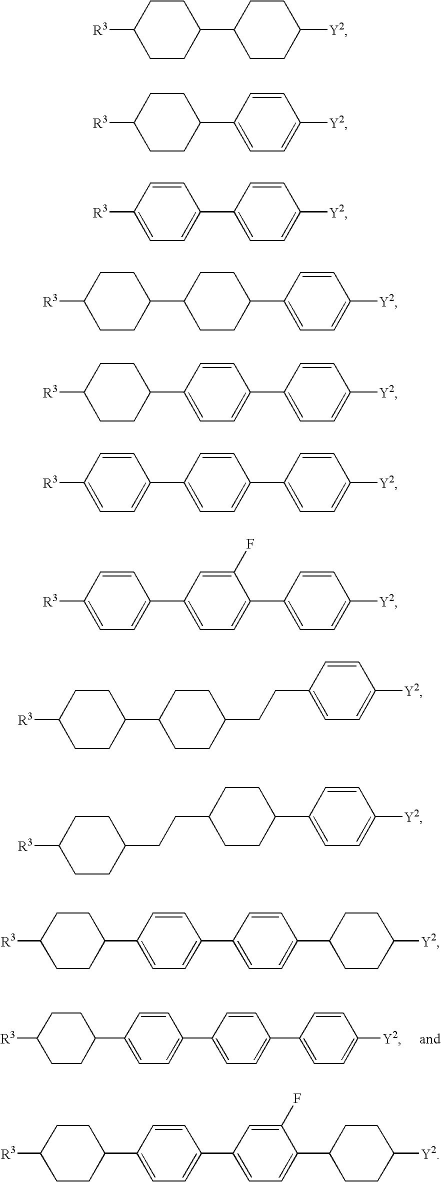

More preferably, examples of the compound (C) include:

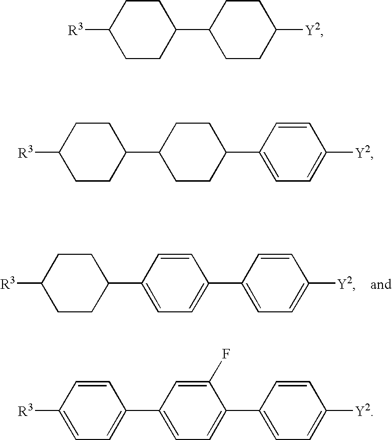

Most preferably, in the compound (C), Y² represents For a linear or branched C₁-C₇ alkyl group, and R³ represents R. R is a linear or branched C₁-C₇ alkyl group, or a linear or branched C₂-C₇ alkyl group having an unsaturated bond. Examples of the compound (C) include:

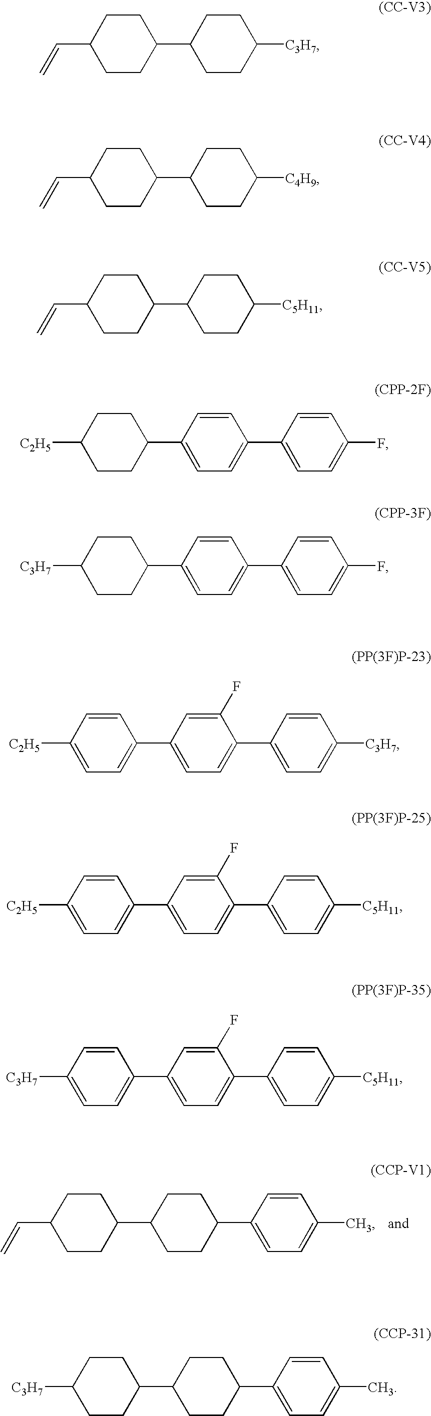

The specific examples of the compound (C) used in the embodiments of this invention include CC-V3, CPP-2F, CPP-3F, PP(3F)P-23, PP(3F)P-25, PP(3F)P-35, CCP-V1, and CCP-31.

### Example

### Preparation of Liquid Crystal Mixtures of Mixtures of Examples 1-11 and Comparative Examples 1-7

The liquid crystal mixtures of Examples 1-11 and Comparative Examples 1-7 were prepared by mixing the first, second, and third compositions, respectively. The compounds (A), (B), and (C) included in the first, second, and third compositions, respectively, and the parts by weight thereof are listed in Table 1.

TABLE 1

| | Composition (A) | Composition (B) | Composition (C) |
|---|---|---|---|
| Example 1 | CPP-3FFF(6.0) | B-CPP-3FF(7.0) | CC-V3(41.0) |
| A_{16.0}B_{7.0}C_{77.0} | PP(3F)P- | | PP(3F)P-23(12.0) |
| | 3FFF(5.0) | | PP(3F)P-25(6.0) |
| | PP-3FF(5.0) | | PP(3F)P-35(5.0) |
| | | | CPP-2F(6.0) |
| | | | CPP-3F(5.0) |
| | | | CCP-V1(2.0) |
| Example 2 | CPP-3FFF(6.0) | B-CPP-3FF(7.0) | CC-V3(39.0) |
| A_{21.0}B_{7.0}C_{72.0} | PP(3F)P- | | PP(3F)P-23(12.0) |
| | 3FFF(5.0) | | PP(3F)P-25(5.0) |
| | PP-3FF(5.0) | | PP(3F)P-35(5.0) |
| | CCP-VFF(2.0) | | CPP-2F(6.0) |
| | CCP-3TF(3.0) | | CPP-3F(5.0) |
| Example 3 | CPP-3FFF(7.0) | B-CPP-3FF(6.0) | CC-V3(40.0) |
| A_{20.5}B_{6.0}C_{73.5} | PP(3F)P- | | PP(3F)P-23(11.5) |
| | 3FFF(5.5) | | PP(3F)P-25(5.0) |
| | PP-3FF(5.0) | | PP(3F)P-35(5.0) |
| | CCP-3TF(3.0) | | CPP-2F(5.0) |
| | | | CPP-3F(5.0) |
| | | | CCP-V1(2.0) |
| Example 4 | CPP-3FFF(8.0) | B-CPP-3FF(7.0) | CC-V3(42.5) |
| A_{20.0}B_{7.0}C_{73.0} | PP(3F)P- | | PP(3F)P-23(11.5) |
| | 3FFF(7.0) | | PP(3F)P-25(5.0) |
| | CCP-3FFF(5.0) | | PP(3F)P-35(5.0) |
| | | | CPP-2F(4.0) |
| | | | CPP-3F(4.0) |
| | | | CCP-31(1.0) |
| Example 5 | CPP-3FFF(8.0) | B-CPP-3FF(7.0) | CC-V3(42.0) |
| A_{15.0}B_{14.0}C_{71.0} | PP(3F)P- | B-CCP-3FF(7.0) | PP(3F)P-23(11.0) |
| | 3FFF(7.0) | | PP(3F)P-25(5.0) |
| | | | PP(3F)P-35(5.0) |
| | | | CPP-2F(4.0) |
| | | | CPP-3F(4.0) |
| Example 6 | CPP-5FFF(6.0) | B-CPP-3FF(8.0) | CC-V3(32.0) |
| A_{18.0}B_{34.0}C_{48.0} | PP(3F)P-3FF(6.0) | B-CCP-3FF(8.0) | PP(3F)P-23(8.0) |
| | CPP-5TF(3.0) | B-CCP-4FF(6.0) | PP(3F)P-25(4.0) |
| | CPP-2OTF(3.0) | B-CP-3F(6.0) | PP(3F)P-35(4.0) |
| | | B-CP-3(6.0) | |
| Example 7 | CPP-3FFF(8.0) | B-CPP-3FF(10.0) | CC-V3(20.0) |
| A_{16.5}B_{44.0}C_{39.5} | CPP-3TF(2.5) | B-CCP-3FF(14.0) | PP(3F)P-23(10.0) |
| | PP(3F)P- | B-CP-3F(20.0) | PP(3F)P-25(4.0) |
| | 3FFF(6.0) | | PP(3F)P-35(4.0) |
| | | | CCP-V1(1.5) |
| Example 8 | CPP-3FFF(6.0) | B-CPP-3FF(6.0) | CC-V3(20.0) |
| A_{14.5}B_{41.0}C_{44.5} | CPP-3TF(2.5) | B-CCP-3FF(10.0) | PP(3F)P-23(12.0) |
| | PP(3F)P- | B-CCP-3FF(6.0) | PP(3F)P-25(10.0) |
| | 3FFF(6.0) | B-CP-3F(19.0) | CCP-V1(2.5) |
| Example 9 | CPP-3FFF(6.0) | B-CPP-3FF(6.0) | CC-V3(20.0) |
| A_{11.0}B_{44.0}C_{45.0} | PP(3F)P-3FF(5.0) | B-CCP-3FF(8.0) | PP(3F)P-23(12.0) |
| | | B-CCP-4FF(8.0) | PP(3F)P-25(5.0) |
| | | B-CP-3F(15.0) | PP(3F)P-35(5.0) |
| | | B-CP-3(7.0) | CCP-V1(3.0) |
| Example 10 | CPP-3FFF(6.0) | B-CPP-3FF(6.0) | CC-V3(13.0) |
| A_{11.0}B_{51.0}C_{38.0} | PP(3F)P-3FF(5.0) | B-CCP-3FF(8.0) | PP(3F)P-23(12.0) |
| | | B-CCP-4FF(8.0) | PP(3F)P-25(5.0) |
| | | B-CP-3F(15.0) | PP(3F)P-35(5.0) |
| | | B-CP-3(7.0) | CCP-V1(3.0) |
| | | B-CP-4(7.0) | |
| Example 11 | CPP-2FF(4.0) | B-CPP-3FF(10.0) | CC-V3(35.0) |
| A_{15.0}B_{25.0}C_{60.0} | PP(3F)-3FF(4.0) | B-CCP-3FF(10.0) | PP(3F)P-23(12.0) |
| | PP-3FF(7.0) | B-CP-3F(5.0) | PP(3F)P-25(5.0) |
| | | | PP(3F)P-35(5.0) |
| | | | CCP-31(3.0) |
| Comparative | CCP-3FFF(5.0) | — | CC-V3(30.0) |
| Example 1 | CCP-4FFF(5.0) | | CP-5F(5.0) |
| A_{25.0}B_{75.0} | PP(3F)P- | | PP(3F)P-23(10.0) |
| | 3FFF(5.0) | | PP(3F)P-25(5.0) |
| | CCP-4TF(10.0) | | CCP-V1(5.0) |
| | | | CPP-3F(5.0) |
| | | | PP(3F)P-4F(10.0) |
| Comparative | PP-3FF(5.0) | — | CC-V3(35.0) |
| Example 2 | CPP-3FFF(10.0) | | PP(3F)P-23(8.0) |
| A_{36.0}B_{64.0} | CCP-2FFF(6.0) | | PP(3F)P-25(4.0) |
| | CCP-3FFF(10.0) | | PP(3F)P-35(4.0) |
| | PP(3F)P- | | CCP-V1(5.0) |
| | 3FFF(5.0) | | CPP-32(3.0) |
| | | | CCP-31(5.0) |
| Comparative | PP-3FF(9.0) | B-CPP-3FF(15.0) | CC-V3(12.0) |
| Example 3 | | B-CCP-3FF(15.0) | CPP-3C1(6.0) |
| A_{9.0}B_{52.0}C_{39.0} | | B-CCP-4FF(10.0) | CCP-V1(5.0) |
| | | B-CP-3(6.0) | PP(3F)P-23(6.0) |
| | | B-CP-4(6.0) | PP(3F)P-25(5.0) |
| | | | PP(3F)P-35(5.0) |
| Comparative | PP-3FF(2.0) | B-CPP-3FF(10.9) | CC-V3(31.0) |
| Example 4 | CPP-2FF(6.9) | | PP-3C1(7.8) |
| A_{29.4}B_{10.9}C_{59.7} | CPP-3FF(13.0) | | PP(3F)P-25(6.3) |
| | PP(3F)P-3FF(7.5) | | CPP-2F(6.0) |
| | | | CPP-3F(6.3) |
| | | | CPP-32(2.3) |
| Comparative | PP-3FF(1.0) | B-CPP-3FF(15.0) | CC-V3(5.0) |
| Example 5 | CPP-5FF(6.0) | B-CCP-3FF(15.0) | PP(3F)P-23(8.0) |
| A_{17.0}B_{57.0}C_{26.0} | | B-CCP-4FF(15.0) | PP(3F)P-25(5.0) |
| | | B-CP-3(6.0) | PP(3F)P-35(5.0) |
| | | B-CP-4(6.0) | CCP-V1(3.0) |
| Comparative | PP(3F)P-3FF(7.0) | B-CPP-3FF(15.0) | CC-V3(34.0) |
| Example 6 | CPP-5FF(10.0) | B-CCP-3FF(10.0) | |
| A_{29.0}B_{37.0}C_{34.0} | CCGP-3FF(10.0) | B-CP-3(6.0) | |
| | CPP-2TF(2.0) | B-CP-4(6.0) | |
| Comparative | PP-3FF(9.0) | B-CPP-3FF(15.0) | CC-V3(9.0) |
| Example 7 | | B-CCP-3FF(15.0) | PP-3F(4.0) |
| A_{9.0}B_{57.0}C_{34.0} | | B-CCP-4FF(15.0) | PP(3F)P-23(7.0) |
| | | B-CP-3(6.0) | PP(3F)P-25(5.0) |
| | | B-CP-4(6.0) | PP(3F)P-35(5.0) |
| | | | CCP-V1(4.0) |

### Test Methods

The liquid crystal mixtures of this invention and the comparative examples were tested for measuring the following properties. The results are shown in Table 2.
(1) Clearing point (Tₙᵢ, ° C.), the temperature at which the liquid crystal mixture is transformed from liquid crystal phase to liquid phase, was measured by heating the liquid crystal mixture using a heater and observing the phase change using a microscope. The clearing point was expected to be greater than 70° C.
(2) Refractive index anisotropy (Δn) was measured using Abbe refractometer at 589.3 nm. According to the requirement for large liquid crystal displays, Δn is preferably greater than 0.11.
(3) Dielectric anisotropy (Δ∈), a difference between the average dielectric constant measured parallel to the long axis of a molecule and the average dielectric constant measured perpendicular to the long axis of the molecule, was measured using LT-938 available from AMT company, Japan, at 25° C. after the liquid crystal mixture was injected into a homogenous alignment test cell and a homeotropic alignment test cell. According to the requirement for large liquid crystal displays, Δ∈ preferably ranges from 3.0 to 7.0.
(4) Threshold voltage (Vth, V) was measured by injecting each of the liquid crystal mixtures to be tested into a cell having a 4 μm wall thickness, and applying a voltage (5V, 64 Hz) to the cell filled with the liquid crystal mixture using DMS-501 available from Autronic company, Germany, so as to obtain a transmission-voltage curve. Vth for each of the liquid crystal mixtures was calculated from the curve using a computer. Vth for large liquid crystal displays in the industry preferably ranges from 1.8 to 2.5 V.
(5) Response time (RT, msec) was measured by injecting each of the liquid crystal mixtures to be tested into a cell having a 4 μm wall thickness, and applying a voltage (6V, 64 Hz) to the cell filled with the liquid crystal mixture using DMS-501 available from Autronic company, Germany. RT for each of the liquid crystal mixtures was calculated using a computer. RT was expected to be smaller than 5.5 msec at 6V.
(6) The lowest storage temperature was determined by depositing 1 to 2 g of each of the liquid crystal mixtures in a 7 ml transparent glass in a freezer at 0 to 40° C. for 240 hours. The lowest storage temperature was one at which no crystal was observed and the mixture still possesses flowability.
(7) Rotational viscosity (γ1, mPa·s) was determined by infecting each of the liquid crystal mixtures to be tested into a homogenous test cell and measuring using a γ1/K device (LC property station, available from Taicol Company, USA) at 25° C.

TABLE 2

| | | | | | | Lowest | |
|---|---|---|---|---|---|---|---|
| | | | | | | storage | |
| | | | | | RT | temp. | |
| | Tₙᵢ | Δn | Δε | Vₜₕ | msec | (T_{L}, ° C.) | γ₁ |
| Ex. 1 | 73.0 | 0.1251 | 3.459 | 2.518 | 4.9 | −20 | 66.69 |
| Ex. 2 | 74.2 | 0.1268 | 3.961 | 2.305 | 5.1 | −20 | 51.21 |
| Ex. 3 | 73.5 | 0.1261 | 3.831 | 2.428 | 4.6 | −20 | 51.32 |
| Ex. 4 | 78.8 | 0.1248 | 4.307 | 2.412 | 4.9 | −20 | 52.83 |
| Ex. 5 | 80.5 | 0.1244 | 4.184 | 2.584 | 4.6 | −20 | 49.99 |
| Ex. 6 | 74.6 | 0.1126 | 5.112 | 1.959 | 5.4 | −20 | 55.53 |
| Ex. 7 | 74.0 | 0.1228 | 5.002 | 1.932 | 4.6 | −20 | 65.45 |
| Ex. 8 | 76.7 | 0.1301 | 5.701 | 2.171 | 4.8 | −30 | 70.59 |
| Ex. 9 | 75.9 | 0.1240 | 4.72 | 2.151 | 5.2 | −20 | 69.97 |
| Ex. 10 | 73.0 | 0.1261 | 5.009 | 2.11 | 5.2 | −20 | 67.76 |
| Ex. 11 | 72.0 | 0.1202 | 3.573 | 2.286 | 4.9 | −20 | 54.52 |
| Comp. | 87.6 | 0.1185 | 3.836 | 2.501 | 6.0 | −10 | 73.75 |
| Ex. 1 | | | | | | | |
| Comp. | 73.4 | 0.1002 | 4.65 | 1.939 | 6.0 | −20 | 60.00 |
| Ex. 2 | | | | | | | |
| Comp. | 72.0 | 0.1211 | 5.257 | 1.932 | 6.6 | −20 | 72.83 |
| Ex. 3 | | | | | | | |
| Comp. | 73.5 | 0.1270 | 5.01 | 2.009 | 5.5 | 10 | 56.19 |
| Ex. 4 | | | | | | | |
| Comp. | 83.4 | 0.1295 | 6.10 | 2.073 | 6.4 | −10 | 113.28 |
| Ex. 5 | | | | | | | |
| Comp. | 71.8 | 0.0932 | 5.25 | 1.812 | 8.8 | 0 | 59.22 |
| Ex. 6 | | | | | | | |
| Comp. | 76.1 | 0.1211 | 5.64 | 1.919 | 6.6 | −10 | 86.41 |
| Ex. 7 | | | | | | | |

It can be noted, from Table 2, that the liquid crystals mixtures according to this invention have a relatively high Δn (0.1126 to 0.1301), a relatively short response time (4.6 to 5.4 msec), a relatively low T_{L} (−20 or −30° C.), an appropriate γ₁ (49.99 to 70.59 mPa·s) and Δ∈ (3.4 to 5.7), which meets the industry requirements for manufacturing large liquid crystal displays. For the comparative examples, the liquid crystal mixtures have response times greater than 5.5 msec, and certain liquid crystal mixtures have Δn less than 0.11, T_{L} higher than −20° C. (e.g., −10, 0, or 10° C.), or γ₁ higher than 80 mPa·s. It might be due to the fact of exclusion of the second composition from the liquid crystal mixture of Comparative Example 1 that the properties of RT and T_{L} of the liquid crystal mixtures in Comparative Example 1 fail to meet the industry requirements. Moreover, in Comparative Examples 3 to 7, since the amounts of the first, second, and third compositions are not controlled to be within the desired ranges, Δn, RT, T_{L}, and γ₁ cannot meet the industry requirements simultaneously. Taking Comparative Example 3 as an example, it might be due to the fact that the first composition is present in 9 parts by weight (not within the range of 10 to 25 parts by weight of this invention), RT (6.6 msec) was measured to be greater than the desired value (<5.5). In Comparative Example 4, by using an amount of the first composition (i.e., 29.4 parts by weight) beyond the required range of 25 parts by weight, the RT is prolonged and the T_{L} value is raised. In Comparative Example 5, it might be due to the fact that the amounts of the second and third compositions are not within the desired ranges, the RT and T_{L} again fail to meet the requirements.

According to the present invention, with the inclusion of 10 to 25 parts by weight of the first composition, 5 to 55 parts by weight of the second composition, and 35 to 80 parts by weight of the third composition, the liquid crystal mixture of this invention provides a shorter response time, a relatively high Δn, and a relatively low T_{L}.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal mixture, comprising:
10 to 25 parts by weight of a first composition including at least one compound having the following formula (A) 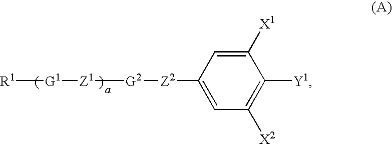
5 to 55 parts by weight of a second composition including at least one perfluoroallyloxy compound having the following formula (B) 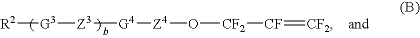
35 to 80 parts by weight of a third composition including at least one compound having the following formula (C) 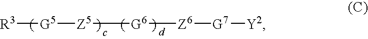
wherein G¹, G², G³, G⁴, G⁵, and G⁶ independently represent 1,4-phenylene, 1,4-cyclohexylene, 2,6-naphthylene, or 2,6-decahydronaphthylene, a —CH═ moiety of the 1,4-phenylene being optionally substituted with —N═, each of hydrogen atoms of the 1,4-phenylene being optionally substituted with a halogen atom or a cyano group, a —CH₂— moiety of the 1,4-cyclohexylene being optionally substituted with —O— or —S—, each of hydrogen atoms of the 1,4-cyclohexylene being optionally substituted with a halogen atom or a cyano group;
G⁷ represents 1,4-phenylene, 3-fluoro-1,4-phenylene, 5-fluoro-1,4-phenylene, 1,4-cyclohexylene, 2,6-naphthylene, or 2,6-decahydronaphthylene;
Z¹, Z², Z³, Z⁵ and Z⁶ independently represent a single bond, —COO—, —OCO—, —CH₂CH₂—, —CH═CH—, —(CH₂)₄—, —CH₂O—, —OCH₂—, —(CH₂)₃O—, —C(CH₂)₃—, —CH═CHCH₂O—, —OCH₂CH═CH—, —C≡C—, —CF₂O—, or —OCF₂—;
Z⁴ represents a single bond or an alkylene group, each of hydrogen atoms of the alkylene group being optionally substituted with a halogen atom or a cyano group;
R¹, R², and R³ independently represent R or RO, R being an alkyl group which optionally has at least one double bond, a —CH₂— moiety of the alkyl group being optionally substituted with —O—, —CO—, or —COO—, and each of hydrogen atoms of the alkyl group being optionally substituted with a halogen atom or a cyano group;
X¹, X², and Y¹ independently represent H, F, —CF₃—, —OCF₃—, —OCF₂H—, or —OCFH₂—, with the proviso that, when X¹ and X² are hydrogen, Y¹ cannot be H, F, or —OCFH₂—;
Y² represents F, Cl, —OCFH₂, a linear or branched C₁-C₇ alkyl group, a linear or branched C₁-C₇ alkoxy group, or a C₂-C₇ alkenyl group, with the proviso that, when G⁷ is 3-fluoro-1,4-phenylene or 5-fluoro-1,4-phenylene, Y cannot be F, Cl, or —OCFH₂;
a is 0, 1 or 2, in which, when a is 2, G¹ and Z¹ in each occurrence are independently the same or different;
b is 1, 2, or 3, in which, when b is 2 or 3, G³ and Z³ in each occurrence are independently the same or different; and
c and d are independently 0, 1, or 2, and c+d>0, in which, when c is 2, G⁵ and Z⁵ in each occurrence are independently the same or different.

2. The liquid crystal mixture of claim 1, wherein said first composition is present in an amount ranging from 10 to 25 parts by weight, said second composition being present in an amount ranging from 6 to 42 parts by weight, said third composition being present in an amount ranging from 44 to 80 parts by weight.

3. The liquid crystal mixture of claim 1, wherein, in said compound (A), G¹ and G² independently represent 1,4-phenylene, 1,4-cyclohexylene, 3-fluoro-1,4-phenylene, 5-fluoro-1,4-phenylene, or 3,5-difluoro-1,4-phenylene.

4. The liquid crystal mixture of claim 3, wherein, in said compound (A), X¹ and X² independently represent H or F, and Y¹ represents F, —CF₃, or —OCF₃, with the proviso that, when X¹ and X² are H, Y¹ is —CF₃ or —OCF₃.

5. The liquid crystal mixture of claim 4, wherein said compound (A) is selected from the group consisting of: 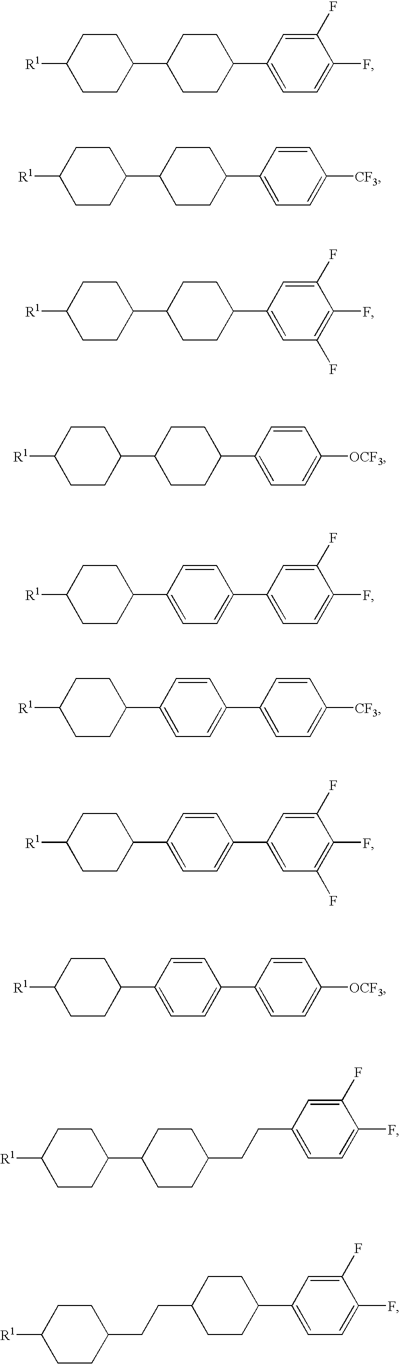 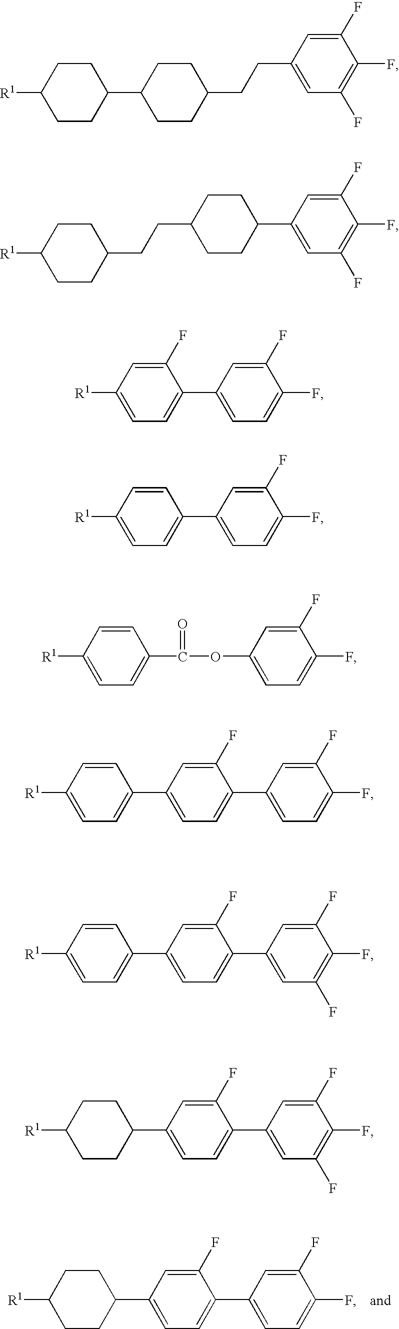
combinations thereof.

6. The liquid crystal mixture of claim 5, wherein, in said compound (A), R¹ represents R or RO, R being a linear or branched C₁-C₇ alkyl group, or a linear or branched C₂-C₇ alkyl group having an unsaturated bond.

7. The liquid crystal mixture of claim 6, wherein said compound (A) is selected from the group consisting of: 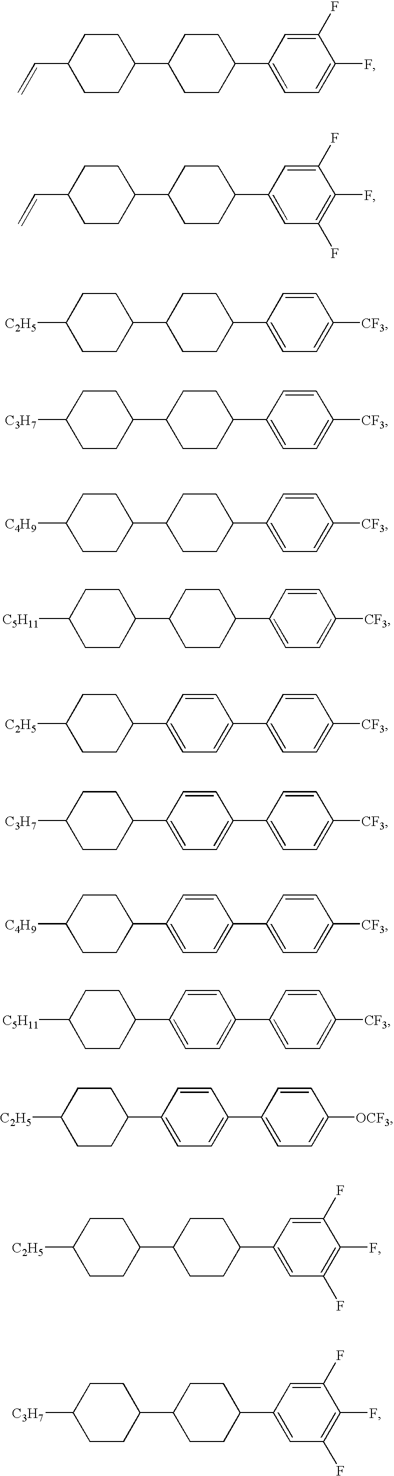 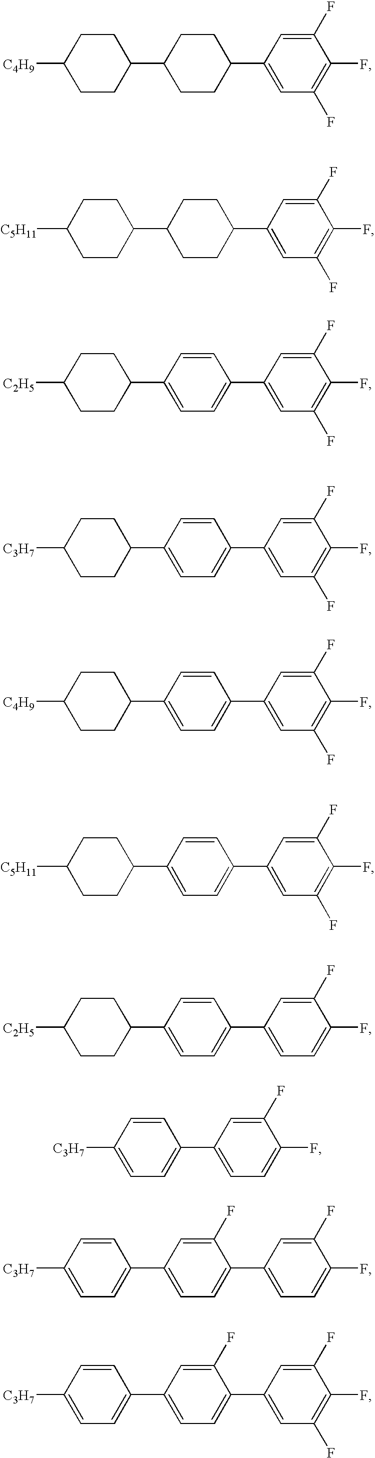 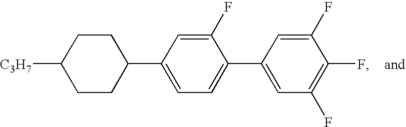
combinations thereof.

8. The liquid crystal mixture of claim 1, wherein, in said perfluoroallyloxy compound (B), G¹ and G⁴ independently represent 1,4-phenylene, 1,4-cyclohexylene, 3-fluoro-1,4-phenylene, 5-fluoro-1,4-phenylene, or 3,5-difluoro-1,4-phenylene.

9. The liquid crystal mixture of claim 8, wherein said perfluoroallyloxy compound (B) is selected from the group consisting of: 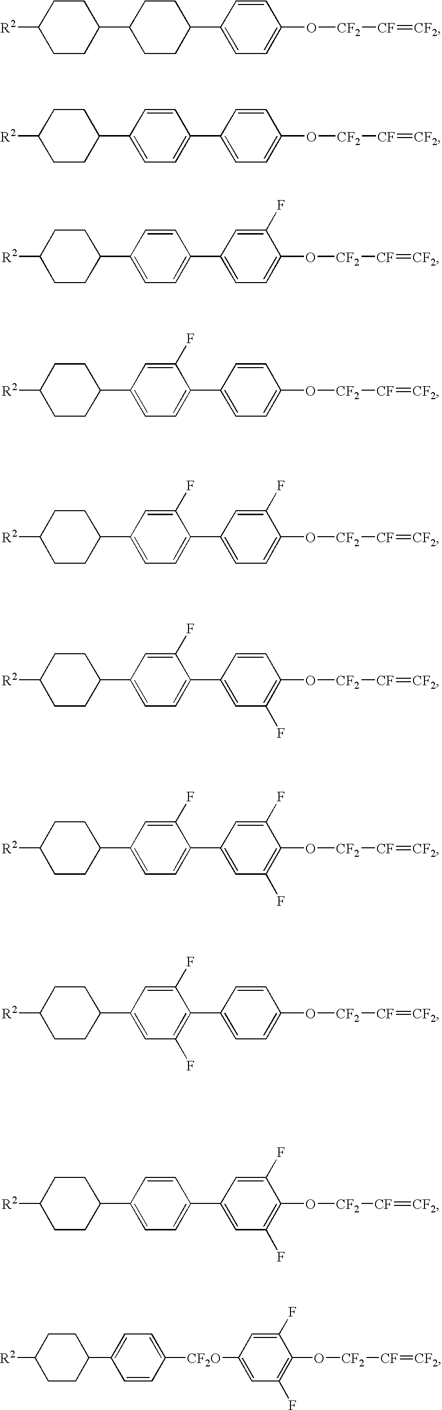 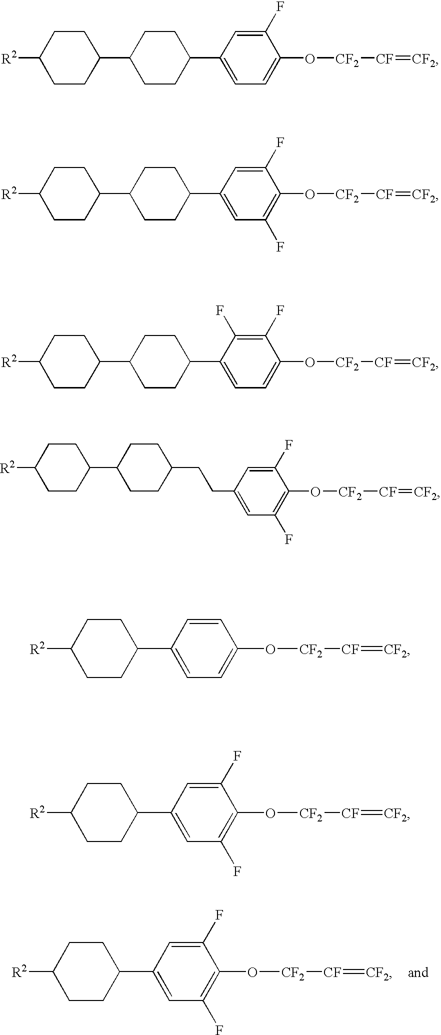
combinations thereof.

10. The liquid crystal mixture of claim 9, wherein, in said perfluoroallyloxy compound (B), R² represents R or RO, R being a linear or branched C₁-C₇ alkyl group, or a linear or branched C₂-C₇ alkyl group having an unsaturated bond.

11. The liquid crystal mixture of claim 10, wherein said perfluoroallyloxy compound (B) is selected from the group consisting of: 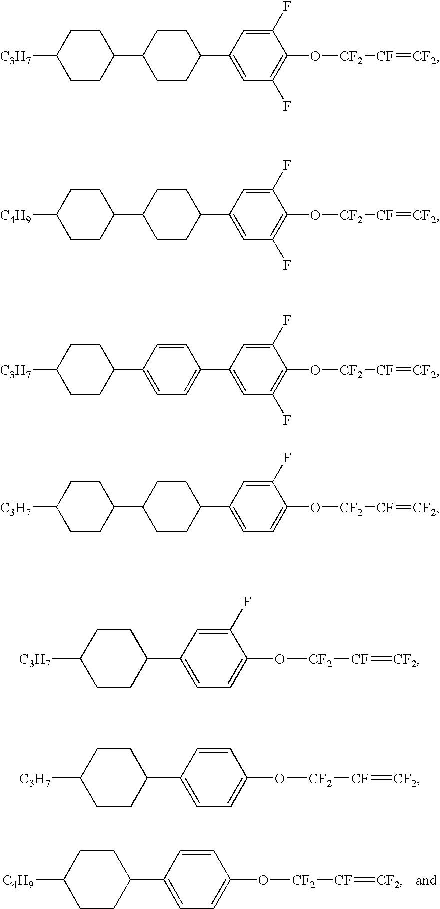
combinations thereof.

12. The liquid crystal mixture of claim 1, wherein, in said compound (C), G⁵, G⁶, and G⁷ independently represent 1,4-phenylene, 3-fluoro-1,4-phenylene, 5-fluoro-1,4-phenylene, 3,5-difluoro-1,4-phenylene, or 1,4-cyclohexylene.

13. The liquid crystal mixture of claim 12, wherein said compound (C) is selected from the group consisting of: 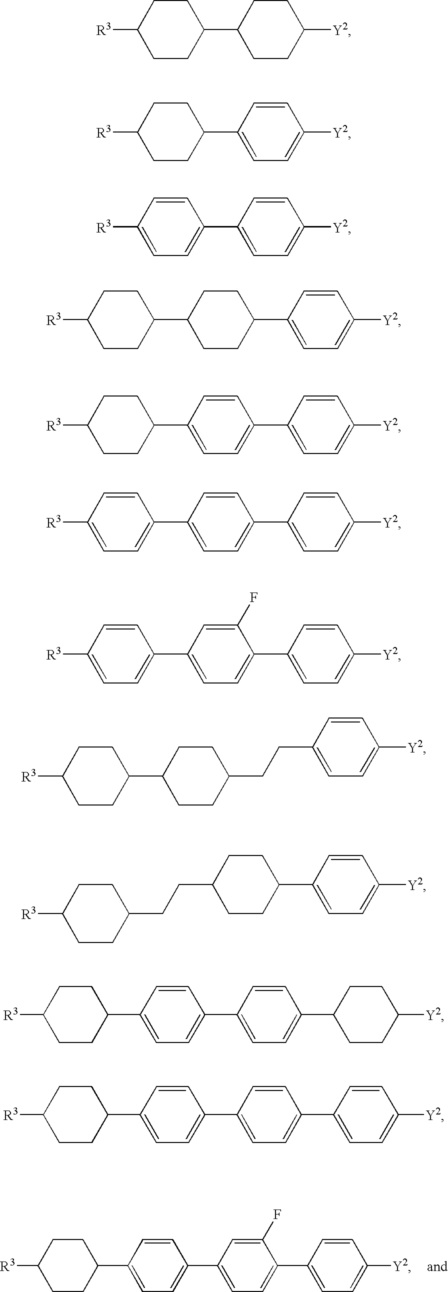
combinations thereof.

14. The liquid crystal mixture of claim 13, wherein, in said compound (C), R represents R³ or RO, R being a linear or branched C₁-C₇ alkyl group, or a linear or branched C₂-C₇ alkyl group having an unsaturated bond.

15. The liquid crystal mixture of claim 14, wherein said compound (C) is selected from the group consisting of: 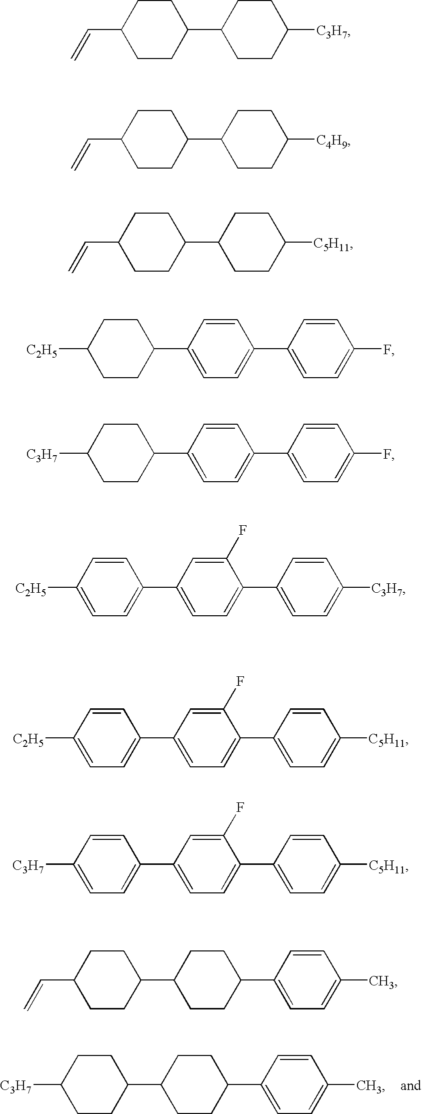
combinations thereof.
